(19) United States
(12) Patent Application Publication
(10) Pub. No.: US 2015/0090536 A1
(43) Pub. Date: Apr. 2, 2015

(54) Touch-free control device for elevator

(71) Applicant: Yan-Chang CHEN, Kaohsiung City (TW)

(72) Inventor: Yan-Chang CHEN, Kaohsiung City (TW)

(21) Appl. No.: 14/499,265

(22) Filed: Sep. 29, 2014

(30) Foreign Application Priority Data
Oct. 1, 2013 (TW) 102218329

(51) Int. Cl. B66B 1/34; G01S 17/08; G01S 15/08

(52) U.S. Cl. CPC B66B 1/34; G01S 15/08; G01S 17/08
USPC 187/389

(57) ABSTRACT

A touch-free control device for an elevator being applicable for an electronically controlled machine of an elevator and contains: a control panel, at least one distance sensor, a microprocessor, and a servo unit. The control panel includes a plurality of keys equidistantly arranged thereon to display a floor direction or a floor number. Each distance sensor is fixed on the control panel to correspond to the plurality of keys, a distance of the sensing signal is parallel to a position of the plurality of keys, and a starting position of the sensing signal of the one distance sensor and a distance between any two keys are used to determine one of the plurality of keys selected by a user. The microprocessor is disposed on the servo unit and is electrically connected with the one distance sensor.

### FIELD OF THE INVENTION

The present invention relates to a touch-free control device for an elevator which selects one of the plurality of keys without touching a control panel

### BACKGROUND OF THE INVENTION

A conventional elevator is controlled in a touch control manner, for example, the conventional elevator is pressed by user's finger to move toward a destination floor. However, such a pressing manner will cause bacterium infection.

The present invention has arisen to mitigate and/or obviate the afore-described disadvantages.

### SUMMARY OF THE INVENTION

The primary objective of the present invention is to provide a touch-free control device for an elevator which selects one of the plurality of keys without touching a control panel.

To obtain the above object, a touch-free control device for an elevator provided by the present invention contains: a control panel, at least one distance sensor, a microprocessor, and a servo unit.

The control panel includes a plurality of keys equidistantly arranged thereon to display a floor direction or a floor number.

Each distance sensor is fixed on the control panel to correspond to the plurality of keys, a distance of the sensing signal is parallel to a position of the plurality of keys, and a starting position of the sensing signal of the one distance sensor and a distance between any two keys are used to determine one of the plurality of keys selected by a user. The microprocessor is disposed on the servo unit and is electrically connected with the one distance sensor.

### BRIEF DESCRIPTION OF THE DRAWINGS

FIG. 1 is a diagram of a touch-free control device according to a preferred embodiment of the present invention.

FIG. 2 is a plane view showing the application of the touch-free control device according to the preferred embodiment of the present invention.

FIG. 3 is another plane view showing the application of the touch-free control device according to the preferred embodiment of the present invention.

FIG. 4 is also another plane view showing the application of the touch-free control device according to the preferred embodiment of the present invention.

FIG. 5 is a plane view showing the operation of the touch-free control device according to the preferred embodiment of the present invention.

FIG. 6 is another plane view showing the operation of the touch-free control device according to the preferred embodiment of the present invention.

FIG. 7 is another plane view showing the application of the touch-free control device according to the preferred embodiment of the present invention.

FIG. 8 is also another plane view showing the operation of the touch-free control device according to the preferred embodiment of the present invention.

FIG. 9 is still another plane view showing the operation of the touch-free control device according to the preferred embodiment of the present invention.

FIG. 10 is a plane view showing the application of the touch-free control device according to another preferred embodiment of the present invention.

FIG. 11 is another plane view showing the application of the touch-free control device according to another preferred embodiment of the present invention.

### DETAILED DESCRIPTION OF THE PREFERRED EMBODIMENTS

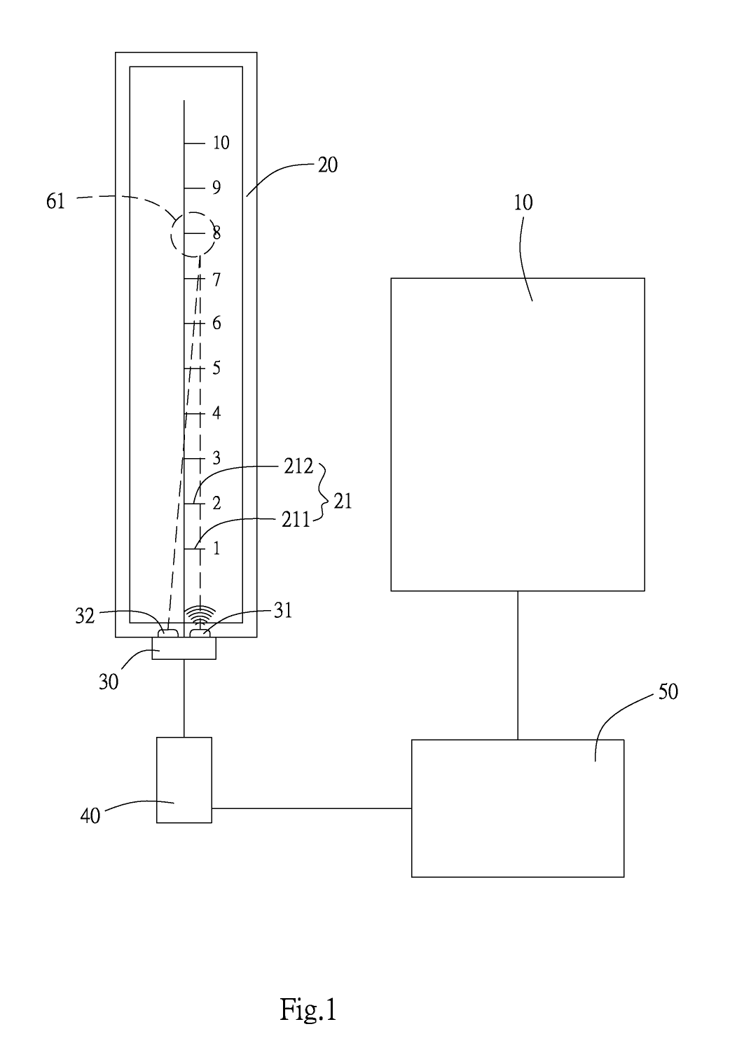

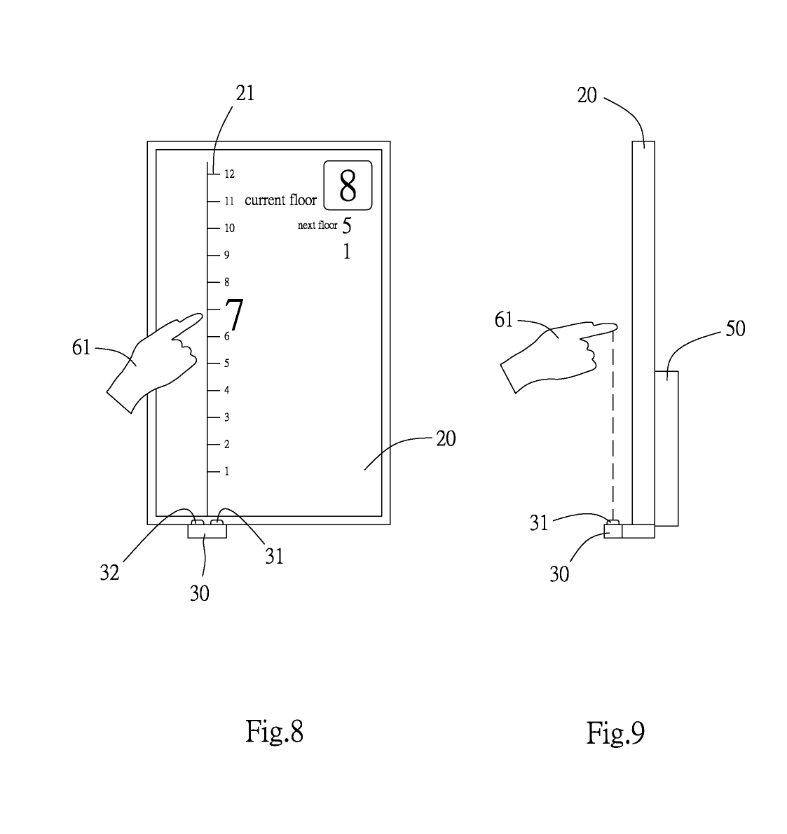

With reference to FIGS. 1 to 11, a touch-free control device according to a preferred embodiment of the present invention is applicable for an electronically controlled machine 10 of an elevator and comprises: a control panel 20, at least one distance sensor 30, a microprocessor 40, and a servo unit 50.

The electronically controlled machine 10 is a well-known art, so further remarks are omitted.

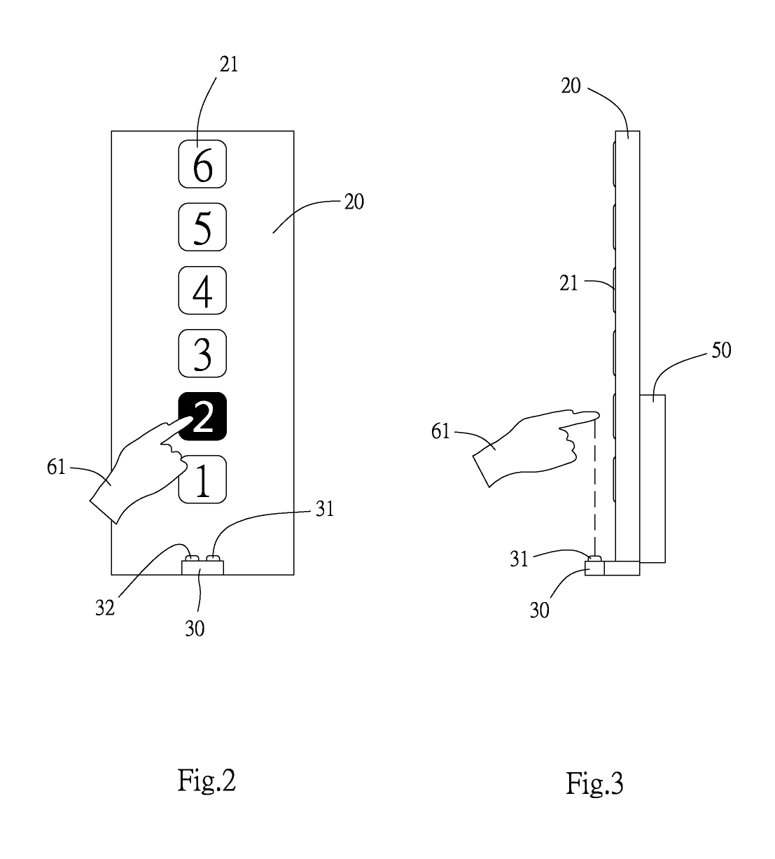

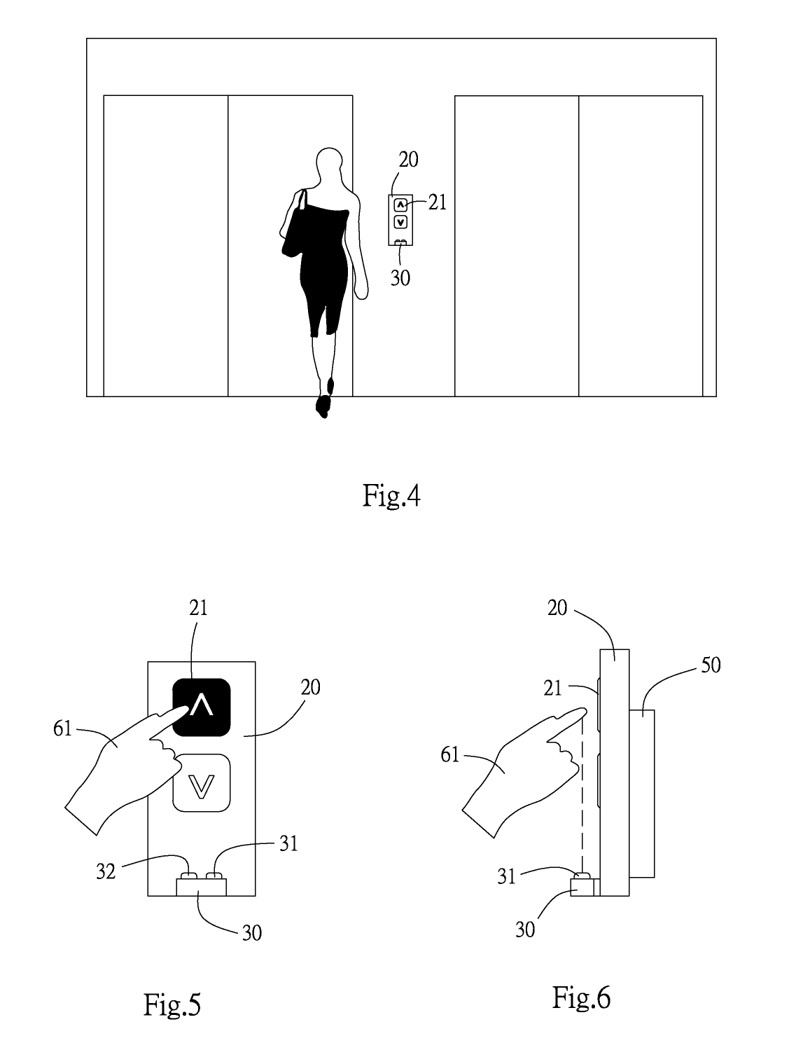

The control panel 20 is configured to control an elevator to move upwardly or downwardly (as shown in FIGS. 4 to 6) or to select a number of a floor (as illustrated in FIGS. 2, 3, and 7 to 9). The control panel 20 includes a plurality of keys 21 equidistantly arranged thereon to display a floor direction or a floor number.

Referring to FIG. 1, each distance sensor 30 includes a transmitting end 31 for transmitting a sensing signal in an ultrasound manner or an infrared ray manner, and each distance sensor 30 also includes a receiving end 32 to receive the sensing signal reflected by an obstacle 61. In one embodiment, one distance sensor 30 is mounted on the control panel 20 to correspond to the plurality of keys 21, wherein a distance of the sensing signal is parallel to a position of the plurality of keys 21, and a starting position of the sensing signal of the one distance sensor 30 and a distance between any two keys 21 are used to determine one of the plurality of keys 21 selected by a user. For instance, a distance between a first-floor key 211 and the starting position of the sensing signal of the one distance sensor 30 represents the first-floor key 211, and a distance between a second-floor key 212 and the starting position of the sensing signal of the one distance sensor 30 denotes the second-floor key 212, etc.

The microprocessor 40 is disposed on the servo unit 50 and is electrically connected with the one distance sensor 30. When the obstacle 61, such as a user's finger or a pen shelters the sensing signal of the one distance sensor 30, the sensing signal is reflected back to the receiving end 32 of the one distance sensor 30, and the microprocessor 40 calculates a transmission time and a reflection time of the sensing signal, transforms the transmission time and the reflection time into a distance signal, and judges a destination floor selected by pressing one of the plurality of keys 21.

The servo unit 50 is configured to receive the distance signal from the microprocessor 40 and to judge one of the plurality of key 21 which is selected to produce the distance signal. Thereafter, the servo unit 50 drives the electronically controlled machine 10 to operate.

As shown in FIGS. 2 to 4 and 6, the distance sensor 30 is fixed on a lower end of the control panel 20 to correspond to the plurality of keys 21, and a circuit system of the control panel 20 is changed to control a movement direction or the destination floor of the elevator, such that when a user presses one of the plurality of keys 21 to move the elevator toward the destination floor, and the user's finger or the pen shelters the sensing signal of the distance sensor 30, the sensing signal is reflected back to the receiving end 32 of the distance sensor 30, and then the microprocessor 40 calculates the transmission time and the reflection time of the sensing signal, transforms the transmission time and the reflection time into the distance signal, and judges the destination floor selected by pressing one of the plurality of keys 21.

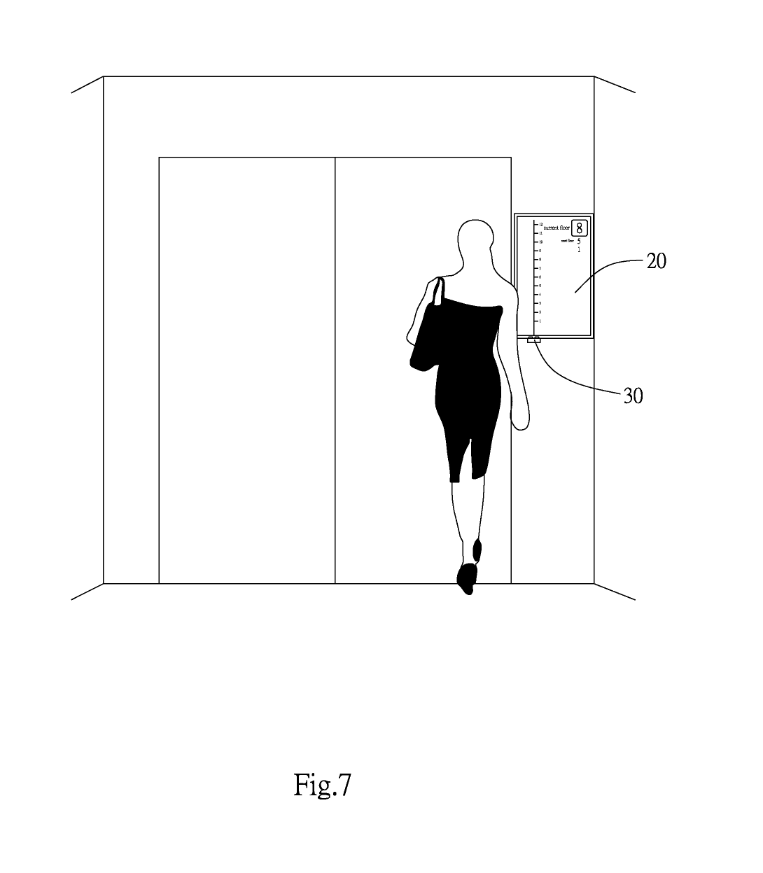

As illustrated in FIGS. 7 to 9, when the control panel 20 is a LCD panel, the distance sensor 30 is fixed on the lower end of the control panel 20 to correspond to the plurality of keys 21, and the control panel 20 displays the floor number and a number of a next floor. When the user presses one of the plurality of keys 21 to move the elevator toward the destination floor, the microprocessor 40 calculates the transmission time and the reflection time of the sensing signal, transforms the transmission time and the reflection time into the distance signal, and judges the destination floor selected by pressing one of the plurality of keys 21. Thereby, the user selects one of the plurality of keys 21 without touching the control panel 20.

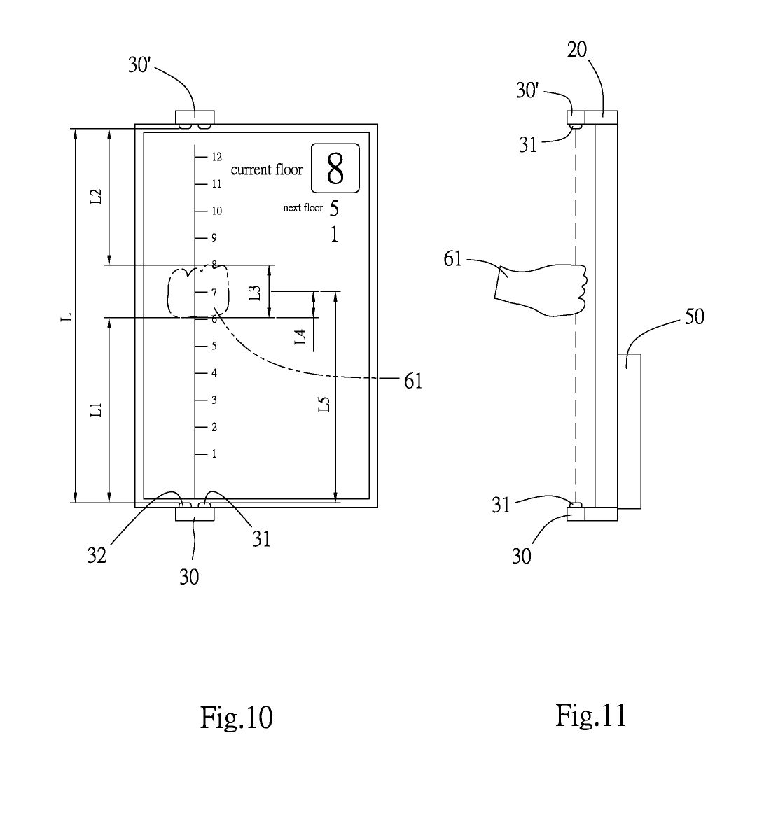

With reference to FIGS. 10 and 11, an auxiliary sensor 30′ is mounted on an upper end of the control panel 20 to correspond to the distance sensor 30, such that the touch-free control device enhances its sensing area and accuracy. For example, when the user points out at least two keys 21 of the control panel 20 with a fist 61, the microprocessor 40 determines a total length L between the distance sensor 30 and the auxiliary sensor 30′, and minus a distance L1 between the distance sensor 30 and the obstacle 61 and a distance L2 between the sensor 30′ and the obstacle 61 to acquire a distance value L3, and the shelter distance value L3 is divided 2 to obtain a half value L4, thereafter the half value L4 plus the distance L1 to acquire a sensed distance L5, hence the sensed distance L5 is applied to judge one of the plurality of keys 21 selected by the user.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A touch-free control device for an elevator being applicable for an electronically controlled machine of an elevator and comprising: a control panel, at least one distance sensor, a microprocessor, and a servo unit, characterized in that:
the control panel includes a plurality of keys equidistantly arranged thereon;
each distance sensor is fixed on the control panel to correspond to the plurality of keys, a distance of the sensing signal is parallel to a position of the plurality of keys, and a starting position of the sensing signal of the one distance sensor and a distance between any two keys are used to determine one of the plurality of keys selected by a user;
the microprocessor is disposed on the servo unit and is electrically connected with the one distance sensor.

2. The touch-free control device for the elevator as claimed in claim 1, wherein each distance sensor includes a transmitting end for transmitting a sensing signal in an ultrasound manner or an infrared ray manner, and each distance sensor also includes a receiving end to receive the sensing signal reflected by an obstacle.

3. The touch-free control device for the elevator as claimed in claim 1, wherein the control panel displays a floor direction or a floor number.

4. The touch-free control device for the elevator as claimed in claim 1, wherein an auxiliary sensor is mounted on an upper end of the control panel to correspond to the distance sensor, when the user points out at least two keys of the control panel, the microprocessor determines a total length between the distance sensor and the auxiliary sensor, and minus a distance between the distance sensor and the obstacle and a distance between the sensor and the obstacle to acquire a distance value, and the shelter distance value is divided to obtain a half value, the half value plus the distance to acquire a sensed distance, hence the sensed distance is applied to judge one of the plurality of keys selected by the user.
